(19) United States
(12) Patent Application Publication
(10) Pub. No.: US 2026/0220405 A1
(43) Pub. Date: Jul. 30, 2026

(54) CODE READER SYSTEM AND METHOD USING CODE READER SYSTEM

(71) Applicant: Keyence Corporation, Osaka (JP)

(72) Inventors: Fumito EBUCHI, Osaka (JP); Yusuke NISHIZAWA, Osaka (JP)

(73) Assignee: Keyence Corporation, Osaka (JP)

(21) Appl. No.: 19/417,396

(22) Filed: Dec. 12, 2025

(30) Foreign Application Priority Data
Jan. 24, 2025 (JP) 2025-010341

(51) Int. Cl. G06K 7/10; G06K 7/14

(52) U.S. Cl. CPC G06K 7/10722; G06K 7/1413; G06K 7/1417

(57) ABSTRACT

A code reader 1 comprises: a composite processing unit 43 that generates a composite image by executing composite processing of a plurality of images based on image features of each of the plurality of images output from a camera; a decoding unit 45 that executes decode processing on the composite image generated by the composite processing unit 43; a calculation unit 46 that calculates an index indicating the accuracy of the composite processing of the plurality of images by the composite processing unit 43; and an output unit 47 that outputs the index to a management device. The management device displays the index calculated for the composite image on which the decode processing by the decoding unit 45 has failed on a display device.

### CROSS-REFERENCE TO RELATED APPLICATIONS

The present application claims foreign priority based on Japanese Patent Application No. 2025-010341, filed Jan. 24, 2025, the contents of which are incorporated herein by reference.

### BACKGROUND OF THE INVENTION

### 1. Technical Field

The present disclosure relates to a code reader system and a method using a code reader system.

### 2. Description of the Related Art

A code reader is disclosed in JP 2016-218588 A, which captures an image of a code attached to a workpiece conveyed by a transport apparatus, and reads the code contained in the captured image.

This type of code reader is used, for example, in logistics sites and other locations.

Meanwhile, when capturing an image of a code attached to a workpiece, there are cases where it is not possible to capture all the regions necessary for decoding at once. Typically, this occurs in situations where a code is attached to the bottom surface of the workpiece and the code on the bottom surface is read through a gap in the conveyor, but there are also other instances where all regions necessary for decoding cannot be captured at once.

In cases where it is not possible to capture all regions necessary for decoding at once, it is considered that code reading becomes possible by capturing a workpiece being transported multiple times to obtain a plurality of images, generating a composite image by compositing these multiple images, and executing decode processing on the generated composite image.

However, even if the composite image appears good to the user's naked eye, it does not necessarily mean that the image quality is suitable for decode processing. Generally, this tendency becomes stronger as the number of composite processing performed to obtain the composite image, that is, the number of images used, increases.

However, there are few cases where users utilizing code readers at sites where code readers are in operation understand the characteristics of composite images as described above. Even if decode processing fails because the composite image is not suitable for decode processing, users can only determine that the composite image is normal when they look at it, resulting in a situation where the cause of the decode processing failure cannot be identified.

### SUMMARY OF THE INVENTION

The present disclosure, having considered such points, resolves the above issue by calculating an index indicating the accuracy of a composite image and presenting it to the user.

To achieve the above-described objective, one aspect of the present disclosure may be premised on a code reader system comprising a code reader that reads a code attached to a workpiece transported on a conveyor, and a management device connected to the code reader and a display device, wherein the management device causes information from the code reader to be displayed on the display device.

The code reader comprises a camera that captures the workpiece multiple times, a memory that stores a plurality of images output from the camera, a composite processing unit that generates a composite image by executing composite processing of the plurality of images based on image features of each of the plurality of images stored in the memory, a decoding unit that executes decode processing on the composite image generated by the composite processing unit, a calculation unit that calculates an index indicating the accuracy of the composite processing of the plurality of images by the composite processing unit, and an output unit that outputs the result of the decode processing by the decoding unit and the index calculated by the calculation unit to the management device. The management device can display on the display device the index calculated for the composite image for which the decode processing by the decoding unit has failed.

According to this configuration, a plurality of images output from the camera are subjected to composite processing by the composite processing unit to obtain a composite image. The decoding unit executes decode processing on the obtained composite image. When the decode processing by the decoding unit fails, an index indicating the accuracy of the composite image that failed is displayed on the display device. At this time, the composite image and the index may be displayed in association with each other, or only the index may be displayed. In either case, since the index is calculated by the calculation unit, it is an index that can appropriately determine whether the image is suitable for decode processing compared to the user's visual judgment of the composite image. Therefore, even if the user judges at first glance that a code is contained in what appears to be a normal composite image, if a low index is displayed on the display device, the user can understand that it was not a composite image suitable for decode processing, thus avoiding spending unnecessary time identifying the cause of the decode processing failure.

In another aspect of the present disclosure, a method using a code reader system can be assumed. The method using the code reader system comprises: a step of capturing the workpiece multiple times by the camera of the code reader; a step of executing composite processing of the plurality of images to generate a composite image by the composite processing unit of the code reader based on the image features of each of the plurality of images; a step of executing decode processing on the composite image by the decoding unit of the code reader; a step of calculating an index indicating the accuracy of compositing of the plurality of images by the calculation unit of the code reader; a step of outputting the result of the decode processing and the index to the management device by the output unit of the code reader; and a step of displaying the index calculated for the composite image for which the decode processing failed on the display device by the management device.

As described above, an index indicating the accuracy of the composite image for which the decode processing failed can be displayed on the display device, making it easier to identify the cause of the decode processing failure.

### BRIEF DESCRIPTION OF THE DRAWINGS

FIG. 1 is a perspective view explaining the operation of a code reader according to an embodiment of the present invention;

FIG. 2 is a block diagram of the code reader;

FIG. 3 is a diagram explaining the operation of the code reader, showing a view from the upstream side in the direction of conveyance;

FIG. 4 is a plan view explaining the operation of the code reader;

FIG. 5 is a schematic diagram showing the relationship between the Scheimpflug optical system and the focal plane;

FIG. 6A is a diagram showing a state where a code attached to the bottom surface of a workpiece is captured from the side of the transport apparatus and below the transport surface;

FIG. 6B is a diagram showing the relationship between the field of view, the focal plane, and the range where focus is achieved of the code reader according to this embodiment;

FIG. 7 is a diagram showing an example of installing the code reader directly below the transport apparatus;

FIG. 8 is a diagram showing an example of installing a code reader whose light receiving window is less than 90 degrees to the horizontal plane directly below the transport apparatus;

FIG. 9 is a diagram showing an example of installing a code reader whose light receiving window is less than 90 degrees to the horizontal plane at the side of the transport apparatus;

FIG. 10 is a diagram showing an example of installing a code reader whose light receiving window is greater than 90 degrees to the horizontal plane directly below the transport apparatus;

FIG. 11 is a diagram explaining how the bottom surface of a workpiece is captured during transport;

FIG. 12 is a flowchart showing an example of a series of processes from image capture to output of reading results;

FIG. 13 is a diagram explaining a case where the bottom surface of a workpiece during transport is captured from the side of the transport apparatus;

FIG. 14 is a flowchart showing an example of a process for presenting an index indicating the accuracy of the composite processing;

FIG. 15 is a diagram showing an example of the composite processing;

FIG. 16 is a diagram showing an example of index display when the accuracy of the composite processing is sufficiently high;

FIG. 17 is a diagram showing an example of index display when the accuracy of the composite processing is relatively high;

FIG. 18 is a diagram showing an example of index display when the accuracy of the composite processing is low;

FIG. 19 is a diagram showing an example of index display when the decode processing fails;

FIG. 20 is an equivalent to FIG. 1 when the code reader system is equipped with multiple code readers;

FIG. 21 is a front view showing the operation when the code reader system is equipped with multiple code readers;

FIG. 22 is a diagram showing an example of a display screen that can be used when removing fixed patterns that appear in images; and

FIG. 23 is a diagram showing an example of a setting screen for determining invalid regions.

### DETAILED DESCRIPTION

Hereinafter, embodiments of the present invention will be described in detail with reference to the drawings. It should be noted that the following description of preferred embodiments is essentially illustrative only and is not intended to limit the invention, its applications, or its uses. For example, the relative sizes and positional relationships of the various components shown in the figures are for describing one embodiment and do not limit the present invention.

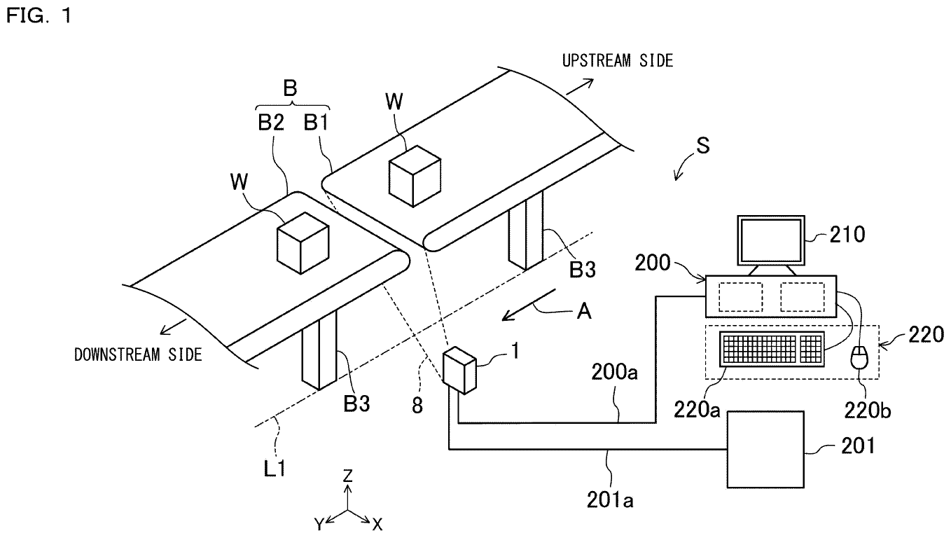

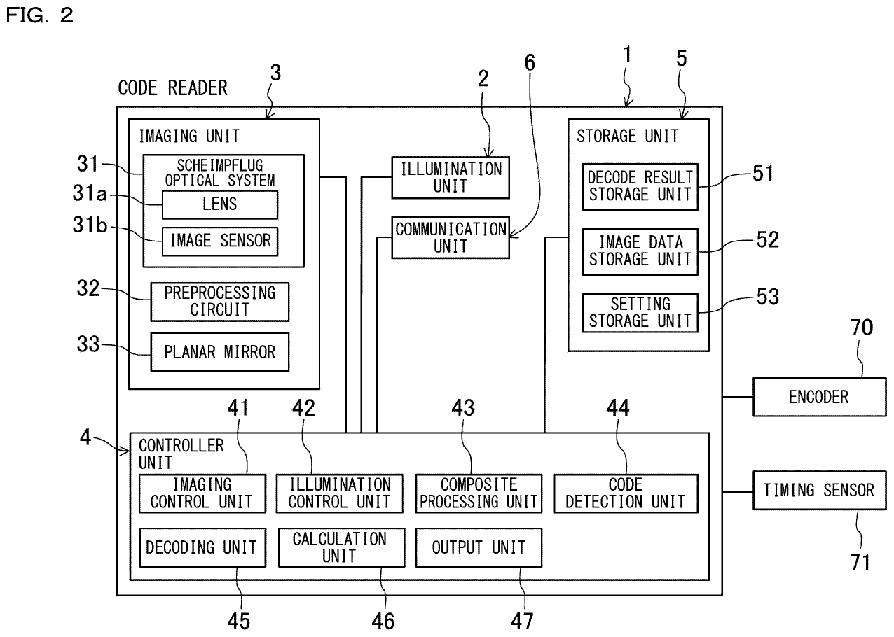

FIG. 1 is a schematic diagram showing the operation of a code reader system S according to an embodiment of the present invention. The code reader system S includes a code reader 1 that reads codes attached to workpieces W transported on a transport apparatus (conveyor) B, and a computer 200. FIG. 2 is a block diagram of the code reader 1 included in the code reader system S.

Computer 200 is an example of a management device, connected to code reader 1 and display device 210, and displays information from code reader 1 on display device 210. The code reader system S may or may not include the display device 210. Computer 200 and display device 210 may be integrated or separate. Computer 200 may function as a management device by installing a program on a general-purpose computer, or may be a computer dedicated to the code reader system S.

The computer 200 is also connected to an operation unit 220. The operation unit 220 is composed of operating equipment for operating the computer 200, and includes, for example, a keyboard 220a and a mouse 220b. The operation unit 220 may include operating equipment other than the keyboard 220a and the mouse 220b, such as pointing devices. The code reader system S may or may not include the operation unit 220.

In this embodiment, a case where the code reader system S is used in a logistics site handling multiple workpieces W is shown. In the logistics site, a transport apparatus B is installed for sequentially transporting multiple workpieces W in a predetermined direction of conveyance. The direction of conveyance of the workpieces W is indicated by arrow A, and therefore the right side in FIG. 1 becomes the upstream side of the direction of conveyance, and the left side in FIG. 1 becomes the downstream side of the direction of conveyance.

The transport apparatus B has a plurality of conveyor elements B1, B2 as conveyor mechanisms. Each conveyor mechanism B1, B2 is constructed of, for example, a belt conveyor or the like, and includes an upstream side conveyor mechanism B1 and a downstream side conveyor mechanism B2. The upper surfaces of the upstream side conveyor mechanism B1 and the downstream side conveyor mechanism B2 serve as the transport surface. In this embodiment, the direction of conveyance of the workpiece W is defined as the Y direction, the direction orthogonal to the Y direction on the transport surface is defined as the X direction, and the direction orthogonal to both the X direction and the Y direction is defined as the Z direction. In logistics sites, the X direction and Y direction are often approximately horizontal, but there are also cases where the Y direction is inclined with respect to the horizontal plane. The X direction can also be called the width direction of the conveyor mechanisms B1, B2, or it can also be called the longitudinal direction of the gap of the transport apparatus B. Also, the Z direction can also be called the height direction (up-down direction). Note that this definition of directions is for explanatory convenience and does not limit the directions during use.

The upstream conveyor element B1 and the downstream conveyor element B2 are provided with a gap in the direction of conveyance. The size (dimension) of the gap between the upstream conveyor element B1 and the downstream conveyor element B2 is not particularly limited, but it is set so that the smallest workpiece W to be transported does not fall through the gap and is smoothly transferred from the upstream conveyor element B1 to the downstream conveyor element B2. The dimension of the gap in the longitudinal direction (dimension in the X direction) is approximately the same as the width (dimension in the X direction) of the conveyor elements B1, B2, but this is not particularly limited either.

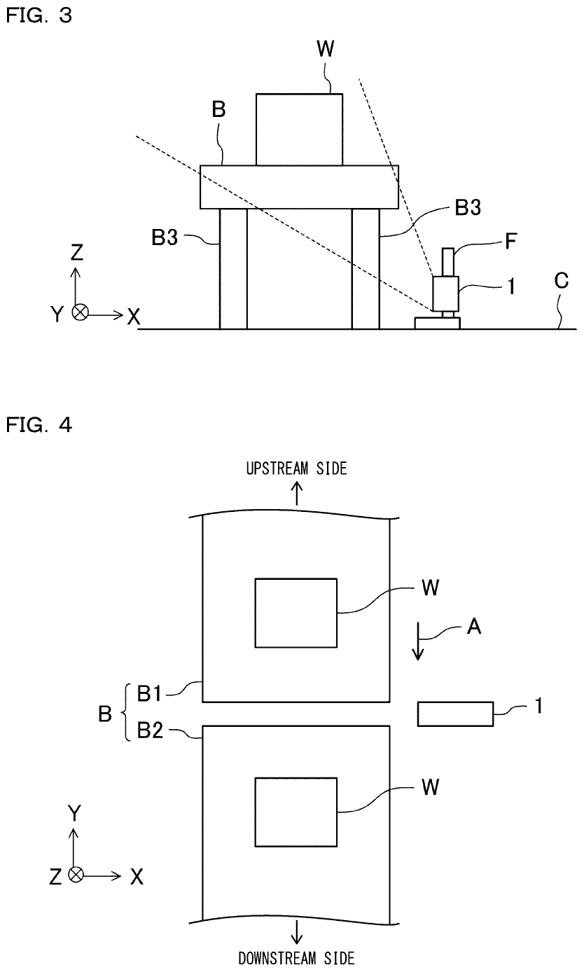

The upstream side conveyor element B1 and downstream side conveyor element B2 are supported on a floor surface C (shown in FIG. 3) by components such as leg part B3. Therefore, since the transport surface of the upstream side conveyor element B1 and downstream side conveyor element B2 is positioned at a predetermined dimension above the floor surface C, a space may be formed below the upstream side conveyor element B1 and downstream side conveyor element B2.

The code reader 1 is installed at an installation position set to the side of the transport apparatus B and below the transport surface of the transport apparatus B. That is, as shown in FIG. 1, when the edge portion in the width direction of the transport apparatus B is projected vertically downward, the edge portion is positioned on a virtual line L1. The virtual line L1 is a line extending in the Y direction. In the top view, the outside of the virtual line L1 relative to the transport apparatus B can be defined as the side of the transport apparatus B. As also shown in FIGS. 3 and 4, the installation position of the code reader 1 in this embodiment is at the side of the transport apparatus B and is set directly to the side of the gap between the conveyor elements B1 and B2.

The broken lines indicated by reference numeral 8 in FIG. 1 and FIG. 2 show the field of view range of the imaging unit 3 (shown in FIG. 2) that the code reader 1 has, which will be described in detail later. The imaging unit 3 corresponds to the camera of the present invention, and the code reader 1 is installed at an installation position so that the gap between the upstream side conveyor element B1 and the downstream side conveyor element B2 is within the field of view range of the imaging unit 3. Therefore, the code reader 1 of this embodiment is a fixed type. The operation time of this fixed type code reader 1 refers to the time when it is performing the operation of sequentially reading codes of workpieces W conveyed by the transport apparatus B. The code reader 1 can be fixed to a vertical fixed surface of a frame F that is fixed to the floor surface C as shown in FIG. 3 via the mounting structure 71A described later, but it may also be fixed via an unillustrated stand or bracket, or may be directly placed and fixed on the floor surface C, or may be fixed to the conveyor elements B1, B2, or may be fixed to the leg part B3, and its installation target is not particularly limited.

Since the gap between the upstream conveyor element B1 and the downstream conveyor element B2 is included in the field of view of the imaging unit 3, when the bottom surface of the workpiece W being conveyed passes through the gap, this bottom surface can be captured by the imaging unit 3. A code may be attached to the bottom surface of the workpiece W. When a code is attached to the bottom surface of the workpiece W, since the code reader 1 is installed at an installation position below the transport surface of the transport apparatus B, the code attached to the bottom surface of the workpiece W can be read from below the transport surface of the transport apparatus B through the gap.

The code attached to the workpiece W includes both barcode and two-dimensional code. Examples of two-dimensional codes include QR code (registered trademark), Micro QR code, Data matrix (Data matrix; Data code), Veri code, Aztec code, PDF417, Maxi code, etc. Two-dimensional codes include stack type and matrix type, but the present invention can be applied to either type of two-dimensional code. The code may be attached by directly printing or engraving on the workpiece W, or by printing on a label and then attaching it to the workpiece W, and the means and method are not limited.

As shown in FIG. 1, the code reader 1 is wired to a computer 200 and a Programmable Logic Controller (PLC) 201 via signal lines 200a and 201a respectively, but this is not limited to such configuration, and the code reader 1, computer 200, and PLC 201 may have built-in wireless communication modules to wirelessly connect the code reader 1 with the computer 200 and PLC 201. The PLC 201 is a control apparatus for sequence control of the transport apparatus B and code reader 1, and a general-purpose PLC can be utilized. The computer 200 can utilize general-purpose or specialized electronic computers or portable terminals.

In addition, the code reader 1, during its operation, receives a read start trigger signal that specifies the start timing of code reading via the signal line 201a from the PLC 201. Then, the code reader 1 performs image capture and decoding of the code based on this read start trigger signal. Subsequently, the decoded result is transmitted to the PLC 201 via the signal line 201a. In this way, during the operation of the code reader 1, the input of the read start trigger signal and the output of the decode result are repeatedly performed between the code reader 1 and external control apparatus such as the PLC 201 via the signal line 201a. The input of the read start trigger signal and the output of the decode result may be performed via the signal line 201a between the code reader 1 and the PLC 201 as described above, or may be performed via another signal line not shown in the figure. For example, a sensor for detecting the arrival of the workpiece W may be directly connected to the code reader 1, and the read start trigger signal may be input from that sensor to the code reader 1.

As shown in FIG. 2, an encoder 70 and a timing sensor 71 are connected to the code reader 1. The encoder 70 is a device capable of detecting the conveyance speed of the transport apparatus B. The code reader 1 can acquire the conveyance speed based on the information (encoder information) output from this encoder 70. Also, the timing sensor 71 is a sensor that detects when the workpiece W arrives at a predetermined position and when it leaves the predetermined position. By means of this timing sensor 71, the code reader 1 can acquire the predicted conveyance speed.

The code reader 1 includes, for example, an illumination unit 2, an imaging unit 3, a controller unit 4, a storage unit 5, and a communication unit 6. The controller unit 4 includes an imaging control unit 41 that controls the imaging unit 3, an illumination control unit 42 that controls the illumination unit 2, a composite processing unit 43, a code detection unit 44, a decoding unit 45, a calculation unit 46, and an output unit 47. The imaging unit 3 and the decoding unit 45 may be separate bodies. Similarly, the imaging unit 3 and the calculation unit 46 and the output unit 47 may be separate bodies.

As a specific configuration example of the controller unit 4, a configuration example including a microcomputer having, for example, a central processing unit, ROM, RAM, etc. can be cited. The imaging control unit 41, illumination control unit 42, composite processing unit 43, code detection unit 44, decoding unit 45, calculation unit 46, and output unit 47 are configured by hardware included in the controller unit 4 or software executed by the controller unit 4. The imaging control unit 41, illumination control unit 42, composite processing unit 43, code detection unit 44, decoding unit 45, calculation unit 46, and output unit 47 may be configured with common hardware or may be configured with separate hardware. Also, a part of the imaging control unit 41, illumination control unit 42, composite processing unit 43, code detection unit 44, decoding unit 45, calculation unit 46, and output unit 47 may be provided outside the housing 60 of the code reader 1.

Further, the storage unit 5 can be composed of a readable and writable storage device such as an SSD (solid state drive). The storage unit 5 can store various programs, decode results, image data, setting information, etc., and has a decode result storage unit 51, an image data storage unit 52, and a setting storage unit 53. Although not shown, the decode result storage unit 51, image data storage unit 52, and setting storage unit 53 may be provided in separate storage devices.

The communication unit 6 is a part that executes communication with the computer 200 and the PLC 201. The setting information from the computer 200 is received by the controller unit 4 via the communication unit 6. Also, the read start trigger signal from the PLC 201 is received by the controller unit 4 via the communication unit 6. The decode result by the code reader 1 is transmitted to the computer 200 and the PLC 201 via the communication unit 6. Furthermore, the communication unit 6 receives the dimension of the gap formed between the plurality of conveyor elements B1, B2 that the transport apparatus B has, and the conveyance speed of the transport apparatus B. The dimension of the gap and the conveyance speed can be input in advance by the user to the computer 200 or the like. The input dimension of the gap and conveyance speed are stored in the computer 200, and the dimension of the gap and conveyance speed are received and acquired by the communication unit 6 after being transmitted from said computer 200.

The illumination unit 2 is a part that irradiates illumination light onto the workpiece W, and the irradiation range of the illumination unit 2 includes the gap between the upstream side conveyor element B1 and the downstream side conveyor element B2. Since the code reader 1 is installed at the side of the transport apparatus B and below the transport surface of the transport apparatus B, the illumination unit 2 irradiates illumination light toward the gap from below the transport surface. As a result, when the bottom surface of the workpiece W being transported passes through the gap between the upstream side conveyor element B1 and the downstream side conveyor element B2, the bottom surface can be illuminated by the illumination unit 2. In the case where a code is attached to the bottom surface of the workpiece W, the code attached to the bottom surface of the workpiece W can be illuminated by the illumination unit 2.

The illumination unit 2 and the imaging unit 3 may be integrated, or the illumination unit 2 and the imaging unit 3 may be separated. The illumination unit 2 is controlled by the illumination control unit 42, which switches between illumination and non-illumination and changes the brightness during illumination. When a read start trigger signal is input from the PLC 201, the illumination control unit 42 illuminates the illumination unit 2 for a predetermined time and turns it off after the predetermined time has elapsed.

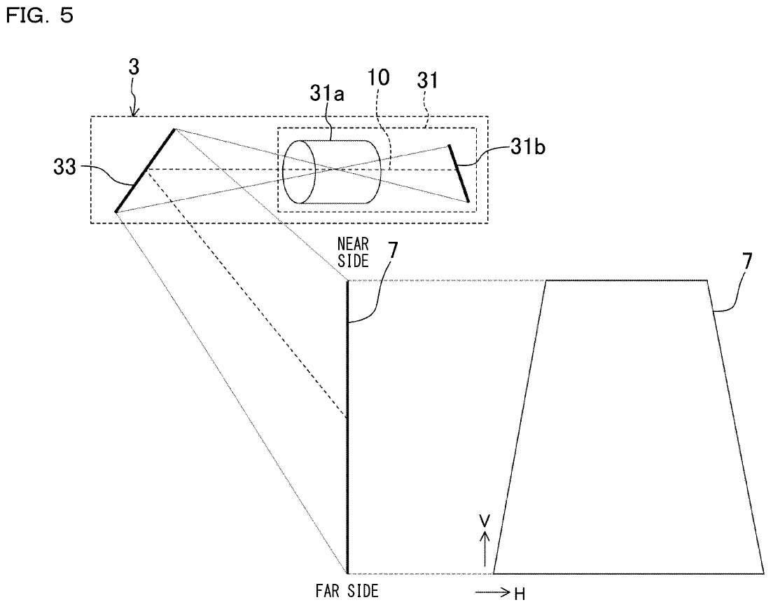

The imaging unit 3 is a portion that captures an image of the workpiece W through a gap between the upstream side conveyor element B1 and the downstream side conveyor element B2 to generate a code image containing a code, and outputs it to the controller unit 4. The imaging unit 3 has a Scheimpflug optical system 31, a preprocessing circuit 32, and a planar mirror 33. As also shown in FIG. 5, the Scheimpflug optical system 31 includes a lens 31a and an image sensor 31b having a light receiving surface inclined with respect to the optical axis 10 of the lens 31a. The lens 31a is an imaging lens that collects reflected light from the bottom surface of the workpiece W. Light incident on the lens 31a is emitted toward the light receiving surface of the image sensor 31b and forms an image on the light receiving surface.

The planar mirror 33 is a member for directing light that has entered the imaging unit 3 toward the lens 31a. In other words, in this example, since it has a Scheimpflug optical system 31, the focal plane 7 is

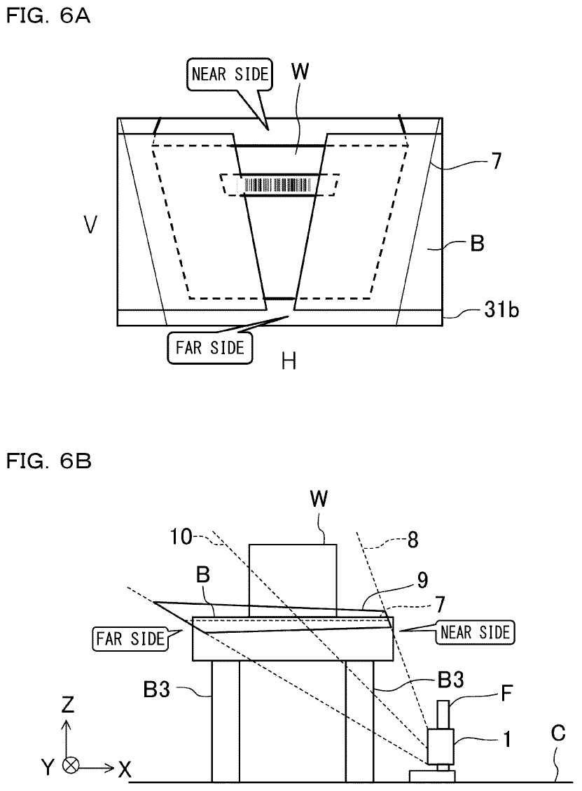

formed to extend in the V direction of the image sensor 31b. FIG. 6A shows a state where a code attached to the bottom surface of the workpiece W is captured from the side of the transport apparatus B and below the transport surface. Also, FIG. 6A shows the shape of the focal plane 7 formed on the light receiving surface of the image sensor 31b, where the near side refers to a relatively close position to the code reader 1, and the far side refers to a relatively distant position from the code reader 1. As shown in FIG. 6A, the gap of the workpiece W or the transport apparatus B appears larger on the near side compared to the far side. In other words, the bottom surface of the workpiece W visible through the gap of the transport apparatus B is projected onto the image sensor 31b in a trapezoidal shape with the long side at one end on the near side, which is relatively close to the imaging unit 3, and the short side at the other end on the far side, which is relatively distant from the imaging unit 3.

In FIG. 6B, the field of view range of the imaging unit 3 is shown by reference numeral 8, and the range where the focus is achieved is shown by reference numeral 9. In addition, the optical axis (the optical axis of the lens 31a) extending through the center of the field of view range 8 is shown by reference numeral 10. Thus, the Scheimpflug optical system 31 has an inclination of the focal plane 7 in the V direction of the image sensor 31b.

As shown in FIGS. 1, 3, and 4, when installing the code reader 1 below the transport surface of the transport apparatus B, the installation position and installation angle of the code reader 1 are adjusted so that the range (depth of field) 9 where the Scheimpflug optical system 31 focuses includes the gap of the transport apparatus B, and the focal plane 7 of the Scheimpflug optical system 31 is substantially parallel to the transport surface.

The image sensor 31b includes a light-receiving element such as a CCD (charge-coupled device) or CMOS (complementary metal oxide semiconductor) that converts the image of the code obtained through the lens 31a into an electrical signal. Based on the amount of light received at the light receiving surface of the image sensor 31b, an image containing the code is generated. The image sensor 31b has a plurality of imaging elements arranged in the row direction and column direction. That is, the imaging unit 3 is an area camera that generates an image with pixels arranged in two dimensions. The image sensor 31b of the imaging unit 3 is configured such that the row direction substantially coincides with the direction from the near side to the far side of the focal plane of the Scheimpflug optical system 31.

That is, if we assume the case of using a line sensor as the image sensor, although high-speed reading is possible, the frame rate may become ultra-high-speed for reading codes, which could increase the heat generation of the illumination unit 2. In this embodiment, by using an area sensor, in which multiple imaging elements are arranged in row direction and column direction, as the image sensor 31b, and by reading it partially, it becomes possible to achieve both heat suppression and high-speed reading.

The image generated by the image sensor 31b is input to the preprocessing circuit 32. The preprocessing circuit 32 may be provided as necessary and is not essential.

The pre-processing circuit 32 is composed of integrated circuits such as FPGA (Field Programmable Gate Array), and is a part that performs various pre-processing operations on images output from the image sensor 31b. The pre-processing includes, for example, various filter processing. The imaging unit 3 outputs images that have been pre-processed by the pre-processing circuit 32 to the controller unit 4. The pre-processing by the pre-processing circuit 32 may be executed as necessary, and images without pre-processing may also be output to the controller unit 4. Images output to the controller unit 4 are stored in the image data storage unit 52 of the storage unit 5.

The imaging unit 3 is controlled by the image capture control unit 41. When a read start trigger signal is input from the PLC 201, the image capture control unit 41 generates an image by exposing for a predetermined exposure time. By the image capture control unit 41 controlling the imaging unit 3, it also executes processing that applies a predetermined gain to the image generated by the image sensor 31b and amplifies the brightness of the image through digital image processing. In addition, the image capture control unit 41 determines the frame rate (number of captures per second) of the imaging unit 3 based on the dimension (width) of the gap between conveyor elements B1, B2 received by the communication unit 6, and the conveyance speed. The image capture control unit 41, for example, sets the frame rate of the imaging unit 3 higher as the conveyance speed increases. The frame rate can be set, for example, in a range from 500 fps to 5000 fps. As the frame rate becomes higher, stronger light is needed to obtain sufficient brightness with a shorter exposure time, so the heat generation of the illumination unit 2 will increase proportionally.

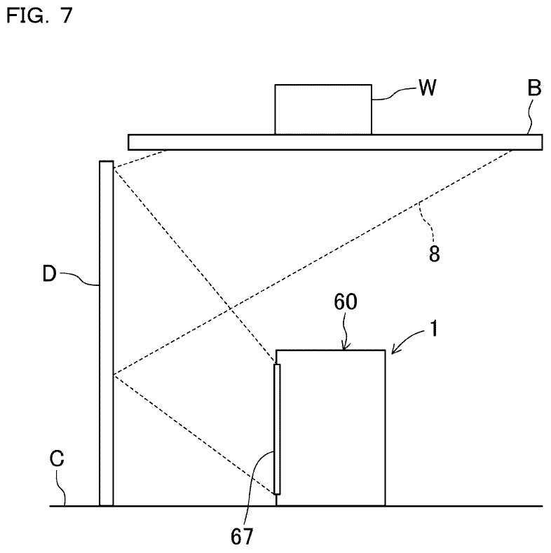

The installation position of the code reader 1 is not limited to only the side of the transport apparatus B. That is, for example, as shown in FIG. 7, if sufficient space can be secured directly under the transport apparatus B, the code reader 1 can also be installed directly under the transport apparatus B. For example, in a plan view, when the code reader 1 is installed such that the optical axis of the lens 31a is approximately parallel to the direction of conveyance A, the imaging unit 3 can be configured to capture images of the bottom surface of the workpiece W from the installation position via a mirror D serving as an external reflective member. In this case, a mirror D extending in an approximately vertical direction is installed at the side of the transport apparatus B, and the reflected light from the bottom surface of the workpiece W can be made to enter the mirror D and be folded downward, then enter the light receiving window 67 formed in the housing 60 of the code reader 1, pass through the light receiving window 67, and enter the imaging unit 3. The code reader 1 according to the example shown in FIG. 7 has a configuration including an external reflective member (mirror D) disposed outside the housing 60.

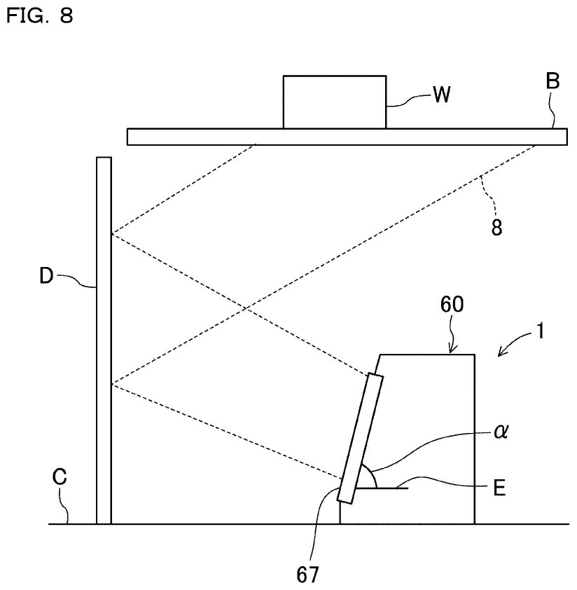

In this example, the angle at which the light receiving window 67 intersects with the horizontal plane is set to 90 degrees, but this is not limited thereto, and as shown in FIG. 8, when the code reader 1 is installed directly below the transport apparatus B, the inclination angle α of the light receiving window 67 with respect to the horizontal plane E may be less than 90 degrees. The inclination angle α may be, for example, 20 degrees or more, or 45 degrees or more.

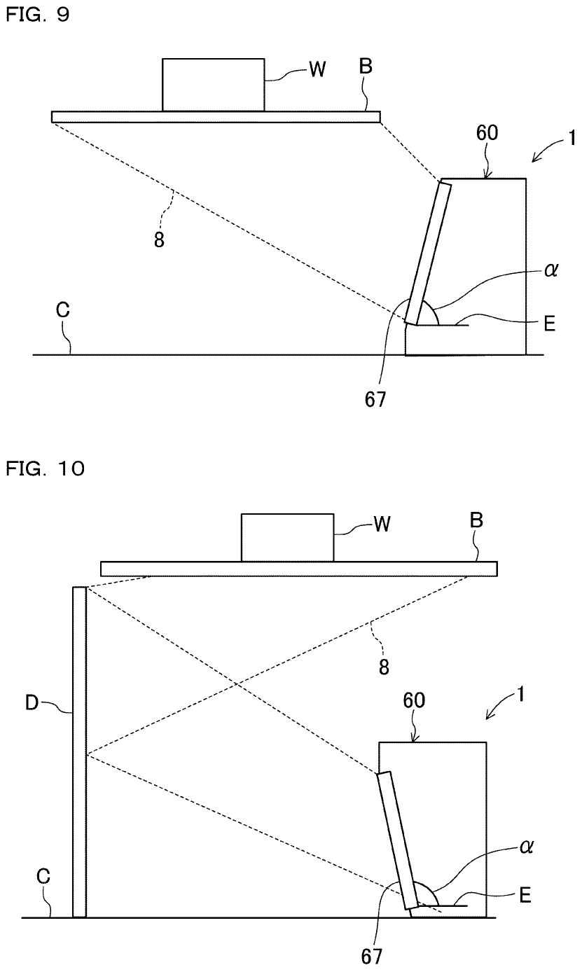

As shown in FIG. 9, the code reader 1 whose light receiving window 67 has an angle less than 90 degrees relative to the horizontal plane E may be installed at the side of the transport apparatus B. Also, as shown in FIG. 10, the code reader 1 whose light receiving window 67 has an angle exceeding 90 degrees relative to the horizontal plane E can be installed directly below the transport apparatus B. In this case, as in the example shown in FIG. 7, the reflected light from the bottom surface of the workpiece W is made to enter the mirror D and folded back downward to enter the light receiving window 67.

In any of the installation configurations shown in FIG. 1, FIG. 3, FIG. 4, and FIG. 7 to FIG. 10, when the housing 60 is installed, the distance between the light receiving window 67 and the gap of the transport apparatus B, the orientation of the light receiving window 67 relative to the gap, etc. are determined. When the housing 60 is installed in a state where the light receiving window 67 is aligned to face the longitudinal direction of the gap of the transport apparatus B in this manner, the imaging unit 3 is configured so that the range where the Scheimpflug optical system 31 is in focus (depth of field) includes the gap of the transport apparatus B. At this time, the intermediate portion of the depth of field of the Scheimpflug optical system 31 includes the gap.

When transporting a workpiece W using the transport apparatus B shown in FIG. 1, the bottom surface of the workpiece W transported by the transport apparatus B is exposed downward through the gap between the upstream side conveyor element B1 and the downstream side conveyor element B2. As shown in FIGS. 1, 3, 4, and 7-10, the depth of field of the imaging unit 3 of the code reader 1 includes the bottom surface of the workpiece W exposed through the gap in the transport apparatus B. This allows the imaging unit 3 to capture images of the bottom surface of the workpiece W through the gap between the upstream side conveyor element B1 and the downstream side conveyor element B2. During this image capture, the row direction of the image sensor 31b corresponds to the direction in which the gap in the transport apparatus B extends, and the column direction of the image sensor 31b corresponds to the direction of conveyance (the direction indicated by arrow A in FIG. 1) of the transport apparatus B.

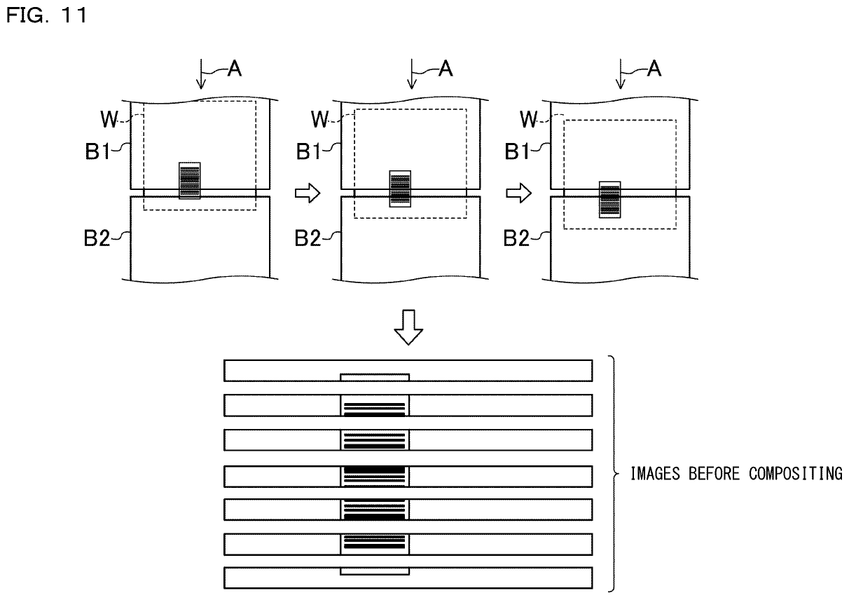

Accordingly, as shown in FIG. 11, the imaging unit 3 continuously captures the bottom surface of the workpiece W that is exposed through a gap in the transport apparatus B and included in the depth of field of the imaging unit 3, thereby outputting multiple images in which a part of the code attached to the bottom surface of the workpiece W is captured. The upper part of FIG. 11 shows a view from below of the upstream side conveyor element B1 and the downstream side conveyor element B2 that are transporting the workpiece W, with the workpiece W being transported from left to right as shown. Since the dimension of the code in the direction of conveyance is longer than the gap between the upstream side conveyor element B1 and the downstream side conveyor element B2, only a part of the code in the direction of conveyance is exposed downward through the gap between the upstream side conveyor element B1 and the downstream side conveyor element B2. As shown in the lower part of FIG. 11, multiple images capturing parts of the code in the direction of conveyance are sequentially output from the imaging unit 3. The multiple images output from the imaging unit 3 are input to the controller unit 4. The images output from the imaging unit 3 become elongated images along the longitudinal direction of the gap between the upstream side conveyor element B1 and the downstream side conveyor element B2 through geometric correction described later.

A plurality of images output from the imaging unit 3 are stored in the image data storage unit (memory) 52. The composite processing unit 43 acquires the plurality of images stored in the image data storage unit 52. The composite processing unit 43 generates a composite image by executing composite processing of the plurality of images based on the image features of each of the acquired plurality of images. The image features can utilize at least one local feature among ORB (Oriented FAST and Rotated BRIEF), SURF (Speeded-Up Robust Features), and SIFT (Scale-Invariant Feature Transform), or edge features, but are not limited to these.

The code detection unit 44 of the controller unit 4 is a part that identifies a code region based on the composite image generated by the composite processing unit 43, and detects a code from the identified code region. The decoding unit 45 of the controller unit 4 executes decode processing on the composite image generated by the composite processing unit 43. Specifically, the decoding unit 45 decodes the code detected by the code detection unit 44. For example, since the code is represented by binarized black and white data, the decoding unit 45 decodes the binarized black and white data. During decode processing, a table showing the correspondence relationship of the encoded data can be used. Furthermore, the decoding unit 45 checks whether the decoded result is correct or not according to a predetermined check method. If an error is found in the data, the correct data is calculated using an error correction function. The error correction function differs depending on the type of code.

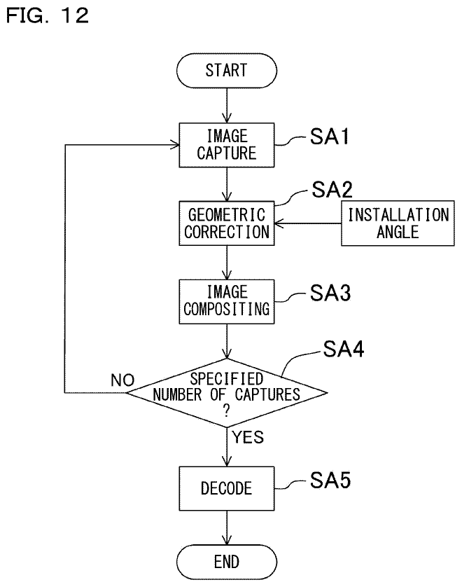

Below, based on the flowchart shown in FIG. 12, I will explain the series of processes from image capture to output of reading results. This flowchart starts at the point when the operation of the code reader 1 begins. After starting, at step SA1, a read start trigger signal is input from the PLC 201 to the code reader 1. When the read start trigger signal is input, the illumination control unit 42 turns on the illumination unit 2, and the imaging control unit 41 causes the imaging unit 3 to capture an image and generate it.

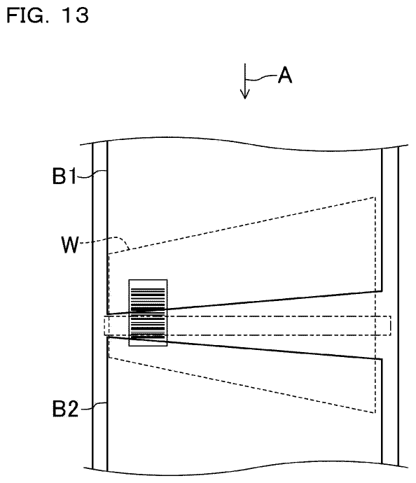

The region enclosed by the two-dot chain line in FIG. 13 is the image output from the imaging unit 3. When the code reader 1 is installed at the side of the transport apparatus B, it captures the bottom surface of the workpiece W diagonally from below. Therefore, unlike when capturing from directly below, geometric changes corresponding to the installation angle of the code reader 1 occur as shown in FIG. 13. Specifically, in multiple images output from the imaging unit 3, the bottom surface of the workpiece W exposed from the gap between the upstream side conveyor element B1 and the downstream side conveyor element B2 appears in a trapezoidal shape with the near side of the focal plane of the Scheimpflug optical system 31 as the long side and the far side of the focal plane of the Scheimpflug optical system 31 as the short side.

Therefore, at step SA2 of the flowchart shown in FIG. 12, the composite processing unit 43 executes trapezoidal correction as geometric correction for the trapezoidal shape of a plurality of images. Specifically, the composite processing unit 43 acquires information related to the installation angle of the code reader 1. The information related to the installation angle of the code reader 1 may be information input by a user during the setup of the code reader 1, or it may be information automatically detected by the code reader 1. The composite processing unit 43 executes geometric correction for each of the plurality of images output from the imaging unit 3 based on the information related to the installation angle of the code reader 1. This enables obtaining an image similar to one captured from directly below the workpiece W. It should be noted that imaging may be performed from directly below the workpiece W, in which case the geometric correction step can be omitted.

In step SA3, the composite processing unit 43 composites multiple post-processed images that have undergone geometric correction in step SA2 to generate a composite image containing a code. Since the compositing is based on image features of each of the multiple images captured using an area camera, it is possible to generate a composite image while accommodating fluctuations in conveyance speed, even if such fluctuations occur.

The composite processing unit 43 composites partial images consisting of a part and a plurality of rows of each image of a plurality of images. More specifically, the composite processing unit 43 determines an overlap width of the plurality of images in the direction of conveyance of the conveyor based on the composite image size, the size of the plurality of images, the conveyance speed of the transport apparatus B, and the installation condition of the code reader 1. At least one of a predetermined lower limit value and an upper limit value is provided for the overlap width. That is, if there is no upper limit value for the overlap width, a case may occur where the plurality of images are completely superimposed on each other, but in that case, the composite processing will not terminate, so by setting an upper limit value for the overlap width, the composite processing can be terminated. On the other hand, if there is no lower limit value for the overlap width, it would result in merely connecting images, but by setting a lower limit value, appropriate composite processing becomes possible.

In step SA4, it is determined whether the number of captures of the imaging unit 3 has reached the specified number. This number is set to a number of captures capable of capturing the entire code. If NO is determined in step SA4, the process proceeds to step SA1, and image capture, geometric correction, and image compositing are repeated until the entire code is captured. If YES is determined in step SA4, the process proceeds to step SA5.

At step SA5, the code detection unit 44 generates multiple edge images by applying multiple edge extraction filters for extracting edges of different frequencies to the image composited in step SA3, and then executes an edge integration process. The code detection unit 44 determines the code candidate position based on the result of the edge integration process. In other words, in the edge-processed image, a region where pixels with high brightness values are concentrated can be estimated as the code region.

For example, the code detection unit 44 can generate a heatmap image representing the likelihood of code to search for the position of the code within the code image. That is, the code detection unit 44 quantifies the feature quantity of the code, generates a heatmap by assigning the magnitude of the feature quantity to each pixel value, and extracts code candidate regions where there is a high possibility that code exists on the heatmap. As a specific example, there is a method of acquiring the characteristic part of the code in regions shown as relatively hot (with large feature quantity) in the heatmap. When multiple characteristic parts are acquired, they can be prioritized for extraction and stored in RAM or the like. By using a heatmap image, it becomes possible to detect code regions at high speed. The decoding unit 45 decodes the code searched by the code detection unit 44.

By executing the composite processing of step SA3, it is possible to obtain a composite image, but even if the compositing position is slightly misaligned, it may appear to the user's visual inspection that the composite processing has succeeded. However, with a composite image where the compositing position is misaligned, the decode processing by the decoding unit 45 may fail. Therefore, when the decode processing fails, it has been difficult for the user to determine whether there is a problem with the composite processing or with the decode processing.

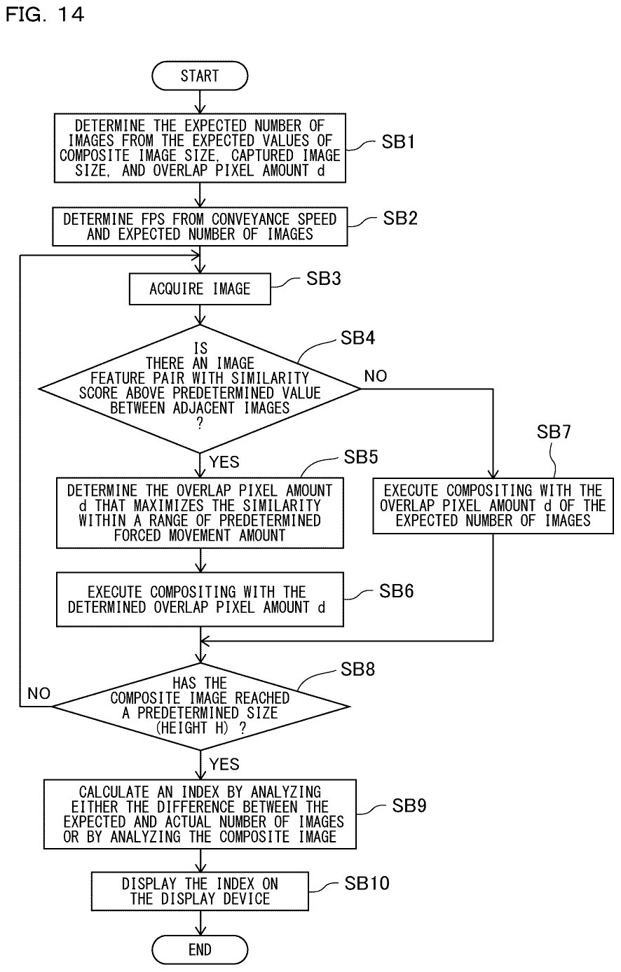

In the present embodiment, by allowing the presentation of an index indicating the accuracy of the composite processing to the user, it becomes possible to easily determine whether the cause of a decode processing failure is due to the composite processing or the decode processing. The details of the presentation processing of the index indicating the accuracy of the composite processing will be explained below based on the flowchart shown in FIG. 14.

The flowchart shown in FIG. 14 starts with the commencement of operation of the code reader 1. In step SB1, the calculation unit 46 calculates the expected number of images that are expected to be necessary to generate a composite image based on the composite image size, the size of the plurality of images captured by the imaging unit 3 (captured image size), the conveyance speed of the transport apparatus B, and the installation condition of the code reader 1. At this time, the calculation unit 46 also acquires the overlap pixel amount d.

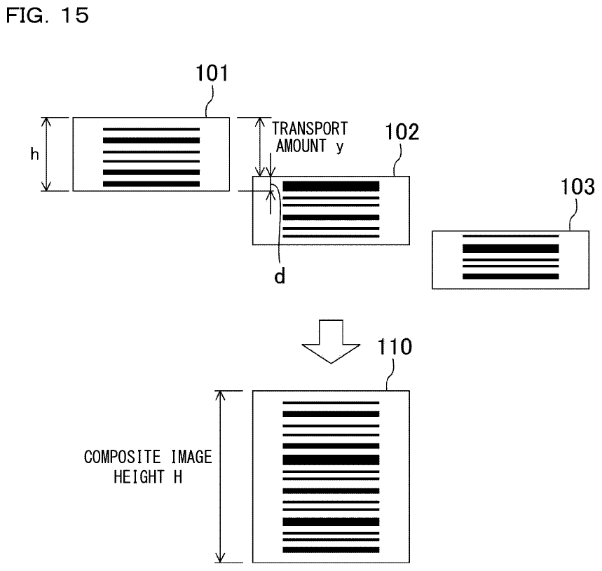

Specifically, as shown as one example in FIG. 15, when generating one composite image 110 by compositing the first to third captured images 101, 102, 103, the height of each of the first to third captured images 101, 102, 103 is defined as h, and the movement amount between the first captured image 101 and the second captured image 102 is defined as y. The movement amount y is the movement amount in the direction of conveyance, and can also be called the transport amount. The overlap pixel amount d is the overlap amount (overlap width) in the moving direction between the first captured image 101 and the second captured image 102, and may be a fixed value or may be determined based on the user's selection operation of the compositing mode. The compositing mode includes, for example, different modes depending on the high or low conveyance speed, and the overlap pixel amount d is changed according to the compositing mode.

Also, let the height of the composite image 110 generated by the composite processing be H. In this case, the calculation unit 46 calculates the expected number of images (n) that is expected to be necessary for generating the composite image based on the following formula.

$$n = ( H - h ) / y + 1 = ( H - h ) / ( h - d ) + 1$$

In step SB2, the calculation unit 46 determines the frame rate (FPS) of the imaging unit 3 from the conveyance speed of the workpiece W and the expected number of images calculated in step SB1. An example of FPS calculation will be explained. When the conveyance speed is V [mm/s], the conveyance direction size of the composite image is H [mm], H can also be referred to as the transport distance of the workpiece W, the time T taken for that transport is H/V [s], and the expected number of images is n [images], the FPS is calculated based on the following formula:

$$FPS = n / ( H / V ) = nV / H [ F P S ]$$

In order to calculate the conveyance direction size H [mm] of the composite image, it is necessary to convert the number of pixels to mm, so the camera parameter and installation condition of the code reader 1 are required. The camera parameter of the code reader 1 includes, for example, the number of pixels, pixel size, angle of view, etc., and the installation condition includes, for example, X coordinate, Y coordinate, Z coordinate, inclination, etc.

In step SB3, the imaging unit 3 executes the image capture process multiple times to obtain a plurality of images. In step SB4, the composite processing unit 43 determines whether there are pairs with image features having a similarity above a predetermined value between temporally adjacent images. If YES is determined, the process proceeds to step SB5. In step SB5, the composite processing unit 43 determines an overlap pixel amount d that maximizes the similarity within a predetermined range of forced movement amount determined based on the lower and upper limits of the overlap width. In step SB6, the composite processing unit 43 executes the composite processing with the overlap pixel amount d determined in step SB5. On the other hand, if NO is determined in step SB4, the process proceeds to step SB7, and the composite processing unit 43 executes the composite processing with the overlap pixel amount d of the expected number of images.

In step SB8, the composite processing unit 43 determines whether the composite image has reached a predetermined size due to the execution of the composite processing. If NO is determined in step SB8 and the composite image has not reached the predetermined size, the process returns to step SB3. On the other hand, if YES is determined in step SB8 and the composite image has reached the predetermined size, the process proceeds to step SB9.

At step SB9, the calculation unit 46 calculates an index indicating the accuracy of the composite processing of a plurality of images by the composite processing unit 43. For example, the calculation unit 46 counts the actual number of images used when actually generating the composite image, and calculates an index indicating the accuracy of the composite processing based on the difference between the expected number of images and the actual number of images. Additionally, the calculation unit 46 can execute image analysis of the composite image and calculate an index indicating the accuracy of the composite processing based on the analysis result.

Based on the difference between the expected number of images and the actual number of images, the calculation unit 46 can calculate an index indicating the accuracy of the composite processing using the following formula.

$$Index = 100 \times \{ ( expected number of images - actual number of images ) / expected number of images \} [ \% ]$$

The index indicating the accuracy of the composite processing can be understood as, for example, a deviation from the expected value, with “0” indicating that the composite processing is as expected. On the other hand, the larger the absolute value of this index, the more it indicates that the composite processing contains many failed regions or significant compositing misalignment. The plus/minus sign indicates the direction of deviation from the expected movement position. In other words, the calculation unit 46 can calculate an index showing whether the actual number of images is greater or less than the expected number of images.

The calculation unit 46 can also adjust the expected number of images in real-time based on at least either the encoder information or the predicted conveyance speed. By acquiring the conveyance speed, it is possible to calculate the optimal expected number of images according to the conveyance speed. Note that during the compositing of one composite image, the initially determined expected number of images is fixed.

The method for calculating the index indicating the accuracy of the composite processing is not limited to the method described above. For example, the degree of misalignment or color inconsistency may be evaluated based on the difference in pixel values in the overlapping portions of adjacent images that are adjacent in the time axis direction, and the index may be calculated based on the evaluation result. Additionally, feature points of adjacent images that are adjacent in the time axis direction may be compared, the degree to which they are appropriately corresponding may be evaluated, and the index may be calculated based on the evaluation result. Furthermore, the degree of smoothness in the changes of color tone or brightness of adjacent images that are adjacent in the time axis direction may be evaluated, and the index may be calculated based on the evaluation result. Also, edges may be detected at the boundary section of adjacent images that are adjacent in the time axis direction, the degree of continuity in brightness or shape may be evaluated, and the index may be calculated based on the evaluation result.

In step SB10, after the output unit 47 outputs the index calculated in step SB9 and the result of the decode processing by the decoding unit 45 to the computer 200, the computer 200 displays the index on the display device 210.

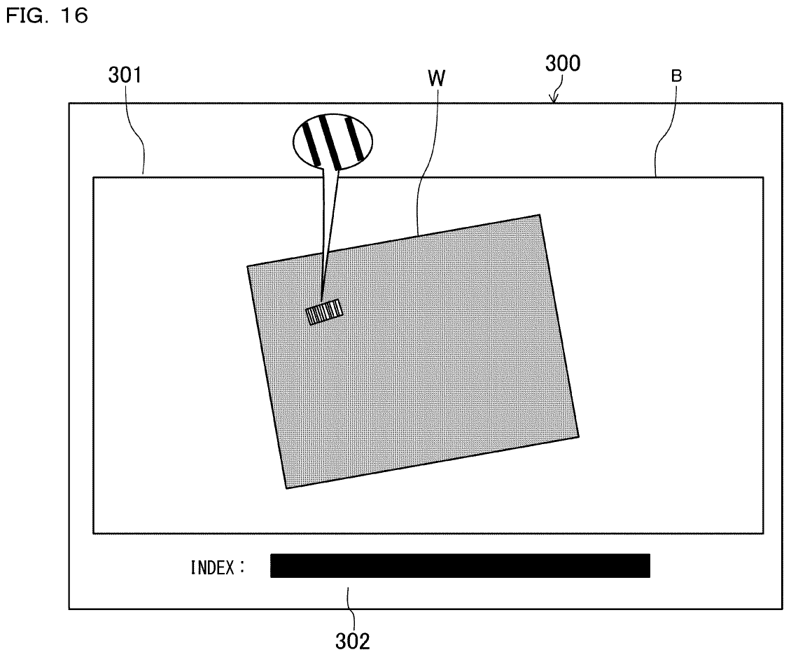

When displaying the index calculated in step SB9 on the display device 210, the computer 200 generates a display screen 300 as shown in FIG. 16, for example, and displays it on the display device 210. The display screen 300 includes an image display region 301 where the transport apparatus B and the workpiece W are displayed, and an index display region 302. In FIG. 16, an image capturing the bottom surface of the workpiece W is displayed in the image display region 301, and a composite image including the code attached to the bottom surface of the workpiece W is displayed. In the index display region 302, the index is displayed as the length of a bar, with a longer bar indicating higher accuracy of the composite image.

In addition, in the index display region 302, the index may be displayed numerically, the color of the bar may be changed according to the size of the index or the length of the bar, or it may be displayed in gradations of color, and the display form is not particularly limited. In FIG. 16, since the accuracy of the composite image is high, as shown in the enlarged part, the code is clear. Note that the enlarged display of a part is an example, and it may not be displayed on the actual display device 210. Also, in FIG. 16, since the accuracy of the composite image is high, the bar is displayed in, for example, green color.

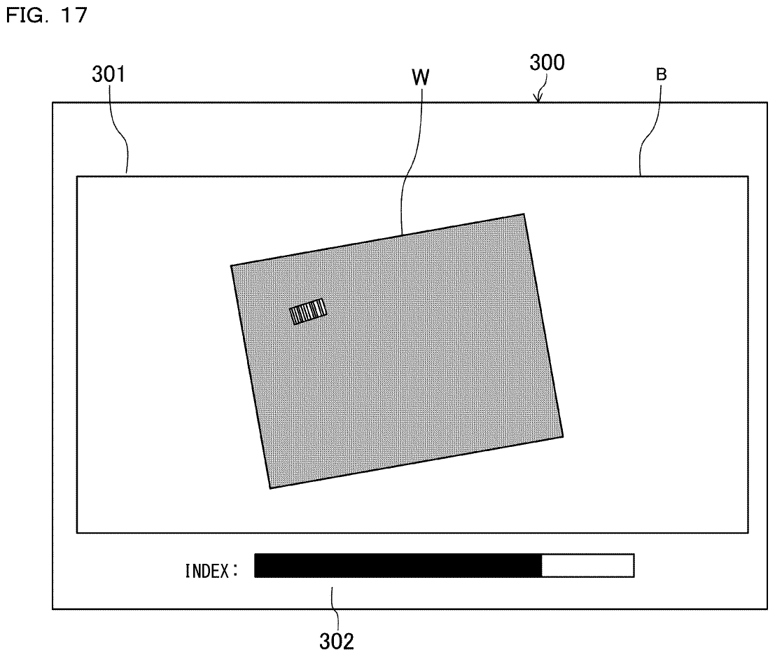

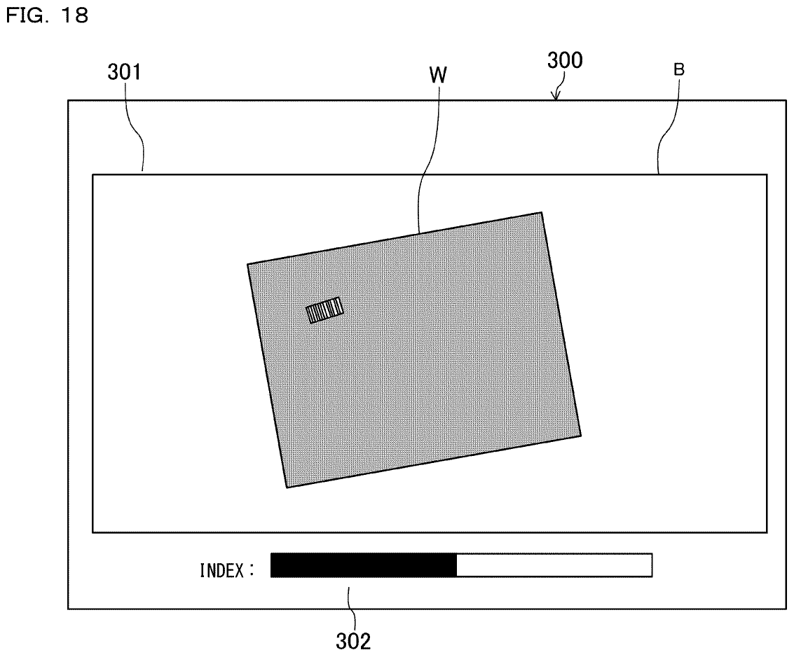

FIGS. 17, 18, and 19 are also examples of displays indicating the accuracy of the composite processing. FIG. 17 is an example where the accuracy of the composite processing is lower than that in FIG. 16 but the decode processing succeeds, and since the accuracy of the composite processing is still relatively high, the bar continues to be displayed in green, for example. FIG. 18 is an example where the accuracy of the composite processing is lower than that in FIG. 17 but the decode processing succeeds; however, as the accuracy of the composite processing has further decreased, the bar is displayed in yellow, for example. As shown in these examples, indicators may be displayed for composite images where decoding has succeeded, but indicators may also not be displayed for composite images where decoding has succeeded.

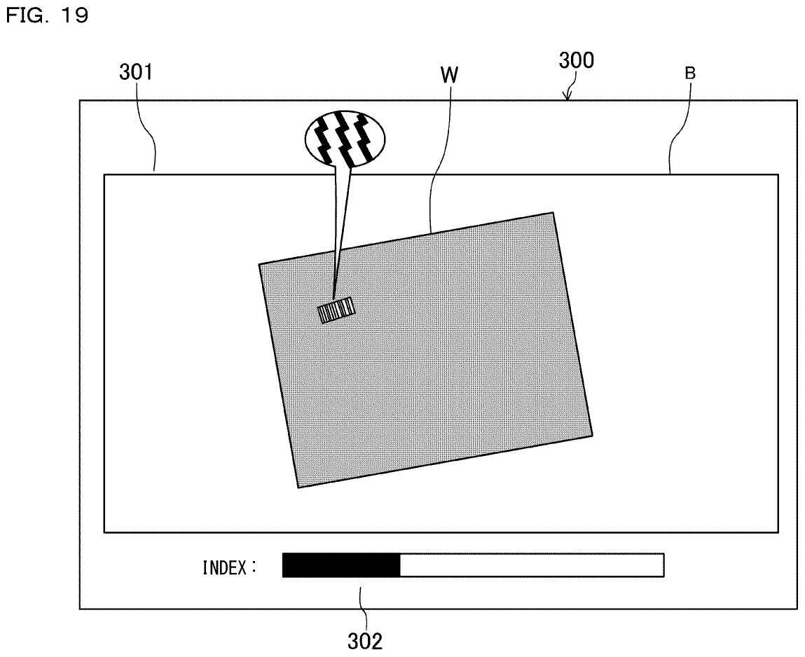

Meanwhile, FIG. 19 shows an example of displaying an index when the decode processing fails. In the display example shown in FIG. 19, although there appears to be no problem with the composite image to the naked eye, the accuracy of the composite image is low, and as shown in the magnified portion, lines that constitute the code that should originally be straight are jagged. For this reason, the decode processing at the decoding unit 45 fails. Also, since the accuracy of the composite processing is low, the bar is displayed in, for example, red color. In this way, the output unit 47 can output both the composite image that failed the decode processing and the index to the computer 200, and the computer 200 can display both the composite image that failed the decode processing and the index on the display device 210. The display format is not particularly limited, and the computer 200 may display only the index calculated for the composite image that failed the decode processing by the decoding unit 45 on the display device 210 without displaying the composite image. In any case, since the index indicating the accuracy of the composite processing can be presented to the user, it is possible to more easily identify the cause of failure in the decode processing.

Factors that reduce the index indicating the accuracy of composite processing include, for example, changes in the conveyance speed such as temporary stops of the transport apparatus B, or cases where the code is farther from the transport surface, such as with workpieces having rounded surfaces.

The plurality of images captured by the imaging unit 3 may include a fixed pattern that is captured regardless of temporal change. The fixed pattern includes any of components of the transport apparatus B, ceiling illumination, or ceiling pattern.

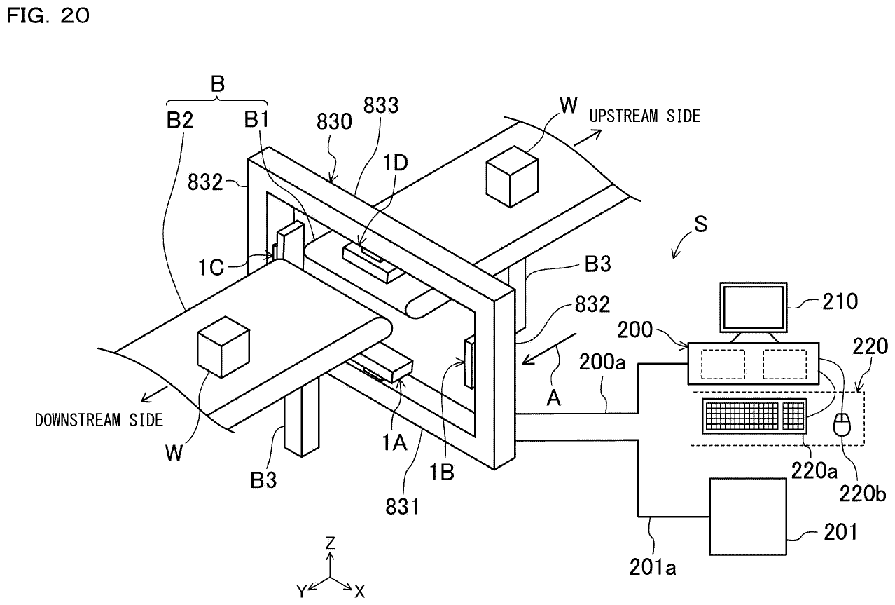

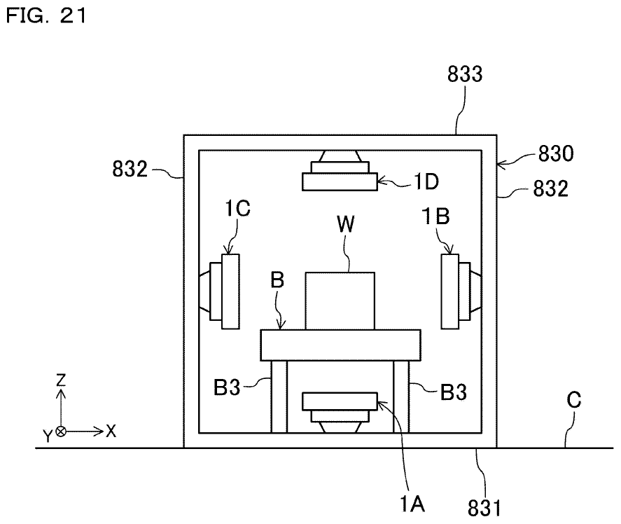

Also, as shown in FIG. 20 and FIG. 21, the code reader system S may include a plurality of code readers 1A, 1B, 1C, 1D. In FIG. 20 and FIG. 21, an example of using four code readers 1A, 1B, 1C, 1D during operation is shown, but the number of code readers during operation is not limited to four, and can be any arbitrary number of three or fewer, or five or more. The code reader 1A is designated as the first code reader 1A, the code reader 1B is designated as the second code reader 1B, the code reader 1C is designated as the third code reader 1C, and the code reader 1D is designated as the fourth code reader 1D.

The first to fourth code readers 1A, 1B, 1C, and 1D are configured to be usable when attached to an external frame (hereinafter simply referred to as a frame) 830. The frame 830 is a frame-shaped frame formed to surround the transport apparatus B, and includes a lower member 831 that is placed below the transport apparatus B and extends in the width direction (X direction) of the transport apparatus B, a pair of side members 832 that extend upward (Z direction) from both longitudinal sides of the lower member 831, and an upper member 833 that extends in the width direction of the transport apparatus B to connect the upper ends of the pair of side members 832. The frame 830 is fixed to, for example, a floor surface C (shown in FIG. 21) or the like.

A first code reader 1A for reading the code attached to the bottom surface of the workpiece W is attached to the lower member 831. The optical axis of the first code reader 1A attached to the lower member 831 is directed upward, and the field of view of the first code reader 1A includes the gap between the upstream side conveyor element B1 and the downstream side conveyor element B2.

Since the gap between the upstream side conveyor element B1 and the downstream side conveyor element B2 is included in the field of view range of the first code reader 1A, when the bottom surface of the workpiece W being transported passes through the gap between the upstream side conveyor element B1 and the downstream side conveyor element B2, the bottom surface can be captured by the first code reader 1A.

A second code reader 1B for reading a code attached to one side surface of the workpiece W is attached to one side member 832. The optical axis of the second code reader 1B attached to one side member 832 is set to face one side surface of the workpiece W.

On the other side member 832, a third code reader 1C is attached to read a code attached to the other side surface of the workpiece W. The optical axis of the third code reader 1C attached to the other side member 832 is set to face the other side surface of the workpiece W.

The fourth code reader 1D for reading a code attached to the upper surface of the workpiece W is attached to the upper member 833. The optical axis of the fourth code reader 1D attached to the upper member 833 is directed downward.

The structure of the above-described frame 830 is one example, and it does not have to be a frame-shaped frame. For example, the frame may be composed only of the lower member 831, only of the side member 832, or only of the upper member 833. Additionally, the frame may be provided with any two of the lower member 831, side member 832, and upper member 833. Furthermore, it is not necessary for code readers to be attached to all of the lower member 831, side member 832, and upper member 833, and code readers may be attached to any one or any two or more of the lower member 831, side member 832, and upper member 833. Moreover, the frame may be fixed to, for example, the transport apparatus B or other members, equipment, etc. Also, the shape of the frame may be straight or may be curved or bent.

In the operational form shown in FIG. 20 and FIG. 21, fixed patterns that are captured in each image regardless of temporal change may include illumination of the code reader located opposite and the frame 830 on which the code reader is installed.

The computer 200 displays a message recommending the removal of fixed patterns that are captured in each image regardless of temporal change on the display device 210 when an index indicating the accuracy of the composite processing is below a predetermined value. The message is intended to prompt either masking the fixed pattern or changing the installation status of the code reader 1 so that fixed patterns are not included. In this way, the user can be notified that the index can be improved by removing the fixed pattern.

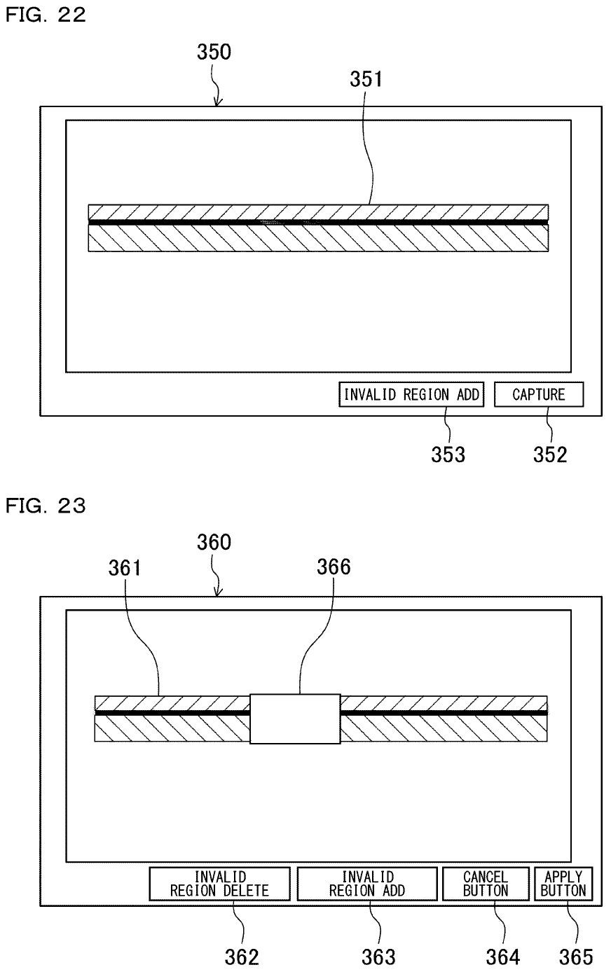

FIG. 22 shows a display screen 350 that is available for users when removing fixed patterns. The display screen 350 is provided with an entire image display region 351 where the image of the entire field of view range of the imaging unit 3 is displayed. In the figure, the hatched portions indicate ranges that are not used during operation, and portions other than the hatched portions (line-shaped portions) are used as part of the composite image. The position of the hatched portions can be changed by the user operating the operation unit 220. By moving the hatched portions so that they overlap with the fixed patterns, it becomes possible to remove the fixed patterns. The display screen 350 is provided with a capture button 352, and when the user operates the capture button 352 after determining the position of the hatched portions, the position of the hatched portions is applied during operation and portions other than the hatched portions are used for composite processing. In this way, the computer 200 can display the display screen 350 as a setting screen for determining the usage range to be used in actual image capture in the field of view of the code reader 1 on the display device 210.

Also, the user can understand which part of the image captures the fixed pattern by looking at the display screen 350. Therefore, while looking at the display screen 350, the user can change the installation status of the code reader 1 so that the fixed pattern does not enter the usage range used in actual image capture.

The computer 200 can also display a setting screen 360 (shown in FIG. 23) on the display device 210 for determining an invalid region that is not used as an image feature in the field of view of the code reader 1. When transitioning to this setting screen 360, the user operates the invalid region add button 353 provided on the display screen 350 shown in FIG. 22.

When the invalid region add button 353 is operated, the computer 200 displays the setting screen 360 shown in FIG. 23 on the display device 210. Similar to FIG. 22, the hatched portions indicate ranges that are not used during operation. The setting screen 360 for determining invalid regions is provided with a whole image display region 361 that displays an image of the entire field of view range of the imaging unit 3, an invalid region delete button 362, an invalid region add button 363, a cancel button 354, and an apply button 365. When the invalid region add button 363 is operated, a region display part 366 indicating the invalid region is superimposed on the whole image display region 361. The portion overlapped by this region display part 366 is designated as an invalid region. The size, shape, and position of the region display part 366 can be changed by the user. Therefore, the size, shape, and position of the invalid region can be arbitrarily determined, making it easy to remove fixed patterns. If you want to delete an invalid region, you can operate the invalid region delete button 362. Also, if you want to set two or more invalid regions, you can operate the invalid region add button 363.

When the apply button 365 is operated after the user has completed setting the invalid region, the setting of the invalid region is applied during operation. On the other hand, when the cancel button 354 is operated, the setting of the invalid region is not applied during operation.

The above-described embodiments are merely exemplary in all respects and should not be interpreted as limiting. For example, in the above-described embodiments, an example where the imaging unit 3 has a Scheimpflug optical system 31 was described, but the configuration of the present disclosure can also be applied to code readers equipped with imaging units having optical systems other than the Scheimpflug optical system. Furthermore, all modifications and changes within the equivalent scope of the claims are within the scope of the present invention.

As explained above, the technology according to the present disclosure can be utilized when reading a code attached to a workpiece.

What is claimed is:

1. A code reader system comprising:
a code reader configured to read a code attached to a workpiece conveyed on a conveyor,
a management device connected to the code reader and a display device, and configured to display information of the code reader on the display device,
wherein the code reader includes:
a camera configured to capture the workpiece multiple times,
a memory configured to store a plurality of images output from the camera,
a composite processing unit configured to generate a composite image by executing composite processing of the plurality of images based on image features of each of the plurality of images stored in the memory,
a decoding unit configured to execute a decode processing on the composite image generated by the composite processing unit,
a calculation unit configured to calculate an index indicating accuracy of the composite processing of the plurality of images by the composite processing unit, and
an output unit configured to output to the management device a result of the decode processing by the decoding unit and the index calculated by the calculation unit,
wherein the management device is configured to display on the display device the index calculated for the composite image for which the decode processing by the decoding unit has failed.

2. The code reader system according to claim 1,
the output unit outputs both the composite image on which the decode processing failed and the index to the management device, and
the management device displays on the display device the composite image on which the decode processing failed and the index.

3. The code reader system according to claim 1, wherein
the code reader is a code reader that captures the code attached to a bottom surface of the workpiece through a gap between conveyor elements of the conveyor,
the camera is an area camera that generates an image with multiple pixels arranged in two dimensions, and
the composite processing unit composites partial images which are a part of each image of the plurality of images and have a plurality of rows, respectively.

4. The code reader system according to claim 1, wherein
the calculation unit:
calculates an expected number of images that are expected to be necessary for generating the composite image based on a size of the composite image, a size of the plurality of images, a conveyance speed of the conveyor, and an installation condition of the code reader,
counts an actual number of images used when generating the composite image, and
calculates the index based on a difference between the expected number of images and the actual number of images.

5. The code reader system according to claim 4,
wherein the calculation unit calculates the index indicating whether the actual number of images is either greater than or less than the expected number of images.

6. The code reader system according to claim 4,
wherein the calculation unit adjusts the expected number of images in real-time based on at least one of encoder information or a predicted conveyance speed.

7. The code reader system according to claim 1,
wherein the composite processing unit determines an overlap width of the plurality of images in the direction of conveyance of the conveyor based on a size of the composite image, a size of the plurality of images, a conveyance speed of the conveyor, and an installation condition of the code reader.

8. The code reader system according to claim 7,
wherein the overlap width is provided with at least one of a predetermined lower limit value and upper limit value.

9. The code reader system according to claim 1, wherein
each image of the plurality of images includes a fixed pattern that appears in regardless of temporal change, and
the management device, when the index is equal to or below a predetermined value, causes the display device to display a message recommending removal of the fixed pattern.

10. The code reader system according to claim 9,
wherein the message prompts to mask the fixed pattern or to change the installation condition of the code reader so that the fixed pattern is not included in each image.

11. The code reader system according to claim 9,
wherein the fixed pattern includes any one of a component of the conveyor, ceiling illumination, ceiling pattern, illumination of a code reader located opposite, or a frame for installing the code reader.

12. The code reader system according to claim 1,
wherein the management device displays on the display device a setting screen for determining a usage range to be used in actual image capture in a field of view of the code reader.

13. The code reader system according to claim 1,
wherein the management device displays on the display device a setting screen for determining an invalid region that is not used as the image feature in a field of view of the code reader.

14. A method using a code reader system including a code reader that reads a code attached to a workpiece conveyed on a conveyor, and a management device connected to the code reader and a display device, which displays information from the code reader on the display device,
the method comprising:
capturing the workpiece multiple times by a camera of the code reader;
executing a composite processing on the plurality of images to generate a composite image based on image features of each of the plurality of images, by a composite processing unit of the code reader;
executing a decode processing on the composite image by a decoding unit of the code reader;
calculating an index indicating accuracy of the composite processing of the plurality of images by a calculation unit of the code reader;
outputting a result of the decode processing and the index to the management device by an output unit of the code reader; and
displaying the index calculated for the composite image for which the decode processing failed, on the display device by the management device.

15. The method using the code reader system according to claim 14, further comprising:
outputting both the composite image on which the decode processing failed and the index to the management device, and
displaying on the display device the composite image on which the decode processing failed and the index.

16. The method using the code reader system according to claim 14, wherein
the code reader is a code reader that captures the code attached to a bottom surface of the workpiece through a gap between conveyor elements of the conveyor,
the camera is an area camera that generates an image with multiple pixels arranged in two dimensions, and
the composite processing composites partial images which are a part of each image of the plurality of images and have a plurality of rows, respectively.

17. The method using the code reader system according to claim 14, further comprising determining an overlap width of the plurality of images in the direction of conveyance of the conveyor based on a size of the composite image, a size of the plurality of images, a conveyance speed of the conveyor, and an installation condition of the code reader.

18. The method using the code reader system according to claim 14, wherein
each image of the plurality of images includes a fixed pattern that appears in regardless of temporal change, and
the method further comprises, when the index is equal to or below a predetermined value, displaying a message recommending removal of the fixed pattern.

19. The method using the code reader system according to claim 14, further comprising displaying on the display device a setting screen for determining a usage range to be used in actual image capture in a field of view of the code reader.

20. The method using the code reader system according to claim 14, further comprising displaying on the display device a setting screen for determining an invalid region that is not used as the image feature in a field of view of the code reader.
